(19) United States
(12) Patent Application Publication
(10) Pub. No.: US 2026/0369660 A1
(43) Pub. Date: Nov. 19, 2026

(54) Solid-State Electrolyte Membrane and Preparation Method Thereof

(71) Applicant: Microvast, Inc., Stafford, TX (US)

(72) Inventors: Haojun QI, Huzhou (CN); Yi ZHENG, Huzhou (CN); Weifeng FANG, Huzhou (CN); Wenjuan Liu MATTIS, Stafford, TX (US)

(73) Assignee: Microvast, Inc., Stafford, TX (US)

(21) Appl. No.: 19/210,018

(22) Filed: May 16, 2025

(51) Int. Cl. H01M 10/056; H01M 10/0525

(52) U.S. Cl. CPC H01M 10/056; H01M 10/0525; H01M 2300/0068; H01M 2300/0082

(57) ABSTRACT

Provided in the present disclosure are solid-state electrolyte membrane and preparation method thereof. The solid-state electrolyte membrane includes a first solid-state electrolyte layer, a base membrane containing a porous structure, and a second solid-state electrolyte layer, which are sequentially stacked in a thickness direction of the solid-state electrolyte membrane. At least a portion of first solid-state electrolyte in the first solid-state electrolyte layer is filled in the porous structure of the base membrane, and the porous structure includes a through hole. A portion of the first solid-state electrolyte is filled in the porous structure of the base membrane, such that mechanical strength is improved, and a battery short circuit caused by punctures is prevented. The through hole causes a contact between the first solid-state electrolyte and a second solid-state electrolyte to be closer, thereby improving lithium ion transmission efficiency.

### TECHNICAL FIELD

The present disclosure relates to the technical field of solid-state electrolyte membranes, and specifically, to solid-state electrolyte membrane and preparation method thereof.

### BACKGROUND

Solid-state electrolytes are a core component of a solid-state battery technology. The solid-state electrolyte replaces the liquid electrolyte used in conventional batteries, which not only can significantly reduce the internal flammability of the battery and improves safety, but also can optimize the energy density and cycling stability of the battery. The solid-state electrolyte is typically composed of inorganic ceramic or polymer materials, and these materials possess high ionic conductivity and good chemical stability, which are key to realizing next-generation, high-performance batteries.

### SUMMARY

A solid-state electrolyte membrane containing a solid-state electrolyte is a key component of a solid-state battery, and plays a role in isolating cathode and anode and preventing internal short circuit, and its microstructure directly affects the transmission of lithium ions inside the battery, thus affecting the electrochemical performance of the battery. However, the solid-state electrolyte membrane faces multiple challenges in industrialized production, the most notable of which is the balance between thickness and performance. If the solid-state electrolyte membrane is too thick, mechanical properties are improved, but the impedance of the battery is increased and the energy density of the battery is reduced; and if the solid-state electrolyte membrane is too thin, a puncture resistance degree is low, and thus the solid-state electrolyte membrane is easily punctured during preparation, leading to a short circuit in the battery.

Therefore, the solid-state electrolyte membrane is required to have an appropriate thickness and a high puncture strength, and reduces the impedance of the battery while ensuring the mechanical strength.

Existing solid-state electrolyte membranes have the problem of being unable to take battery impedance and energy density into consideration while ensuring the mechanical properties.

Furthermore, the preparation process of the solid-state electrolyte membrane also poses a challenge for industrialized production. Continuous production requires the solid-state electrolyte membrane with a highly uniform thickness and homogeneous structure to ensure the performance stability of the battery. However, existing processes such as coating, calendering and the like are difficult to simultaneously meet the requirements of thickness control, mechanical strength and electrochemical performance, especially in large-scale production conditions, how to maintain the uniformity and consistency of a membrane layer has become an urgent problem.

Therefore, the development of a solid-state electrolyte membrane that can reduce battery impedance while ensuring mechanical properties and can also match continuous production operations is important for promoting the commercialization of the solid-state battery technology. This requires in-depth research and innovation in material selection, microstructure design, and preparation processes for the solid-state electrolyte membranes to overcome the above challenges, thereby realizing the large-scale production of high-performance solid-state batteries.

The present disclosure is mainly intended to provide a solid-state electrolyte membrane and a preparation method thereof.

In order to implement the above objective, an aspect of the present disclosure provides a solid-state electrolyte membrane. The solid-state electrolyte membrane includes a first solid-state electrolyte layer, a base membrane containing a porous structure, and a second solid-state electrolyte layer, which are sequentially stacked in a thickness direction of the solid-state electrolyte membrane. At least a portion of first solid-state electrolyte in the first solid-state electrolyte layer is filled in the porous structure of the base membrane, and the porous structure includes a through hole.

As an implementation, the above porous structure further includes staggered holes.

As an implementation, the first solid-state electrolyte accounting for 30 wt %-70 wt % of the total mass of the above first solid-state electrolyte layer is filled in the porous structure of the base membrane, or the first solid-state electrolyte accounting for 40 wt %-60 wt % of the total mass of the above first solid-state electrolyte layer is filled in the porous structure of the base membrane.

As an implementation, mechanical strength of the above solid-state electrolyte membrane is 20 MPa-100 MPa; and/or ionic conductivity of the above solid-state electrolyte membrane is 1×10⁻⁵ S/cm-9×10⁻³ S/cm; and/or impedance of the above solid-state electrolyte membrane is 10Ω-1100Ω.

As an implementation, melting points of the base membrane and the second solid-state electrolyte in the second solid-state electrolyte layer both are higher than a melting point of the first solid-state electrolyte in the first solid-state electrolyte layer.

As an implementation, a pore diameter of the above through hole is 25 μm-150 μm, or 30 μm-50 μm; and/or a gap between the adjacent through holes is 10 μm-200 μm, or 10 μm-50 μm.

As an implementation, an air permeability rate of the base membrane is 70%-80%;
and/or a through hole rate of the base membrane is 50%-60%; and porosity of the base membrane is 70%-90%.

As an implementation, a melting point of the base membrane is 200 °C-600 °C, or 300 °C-400 °C.

As an implementation, a thickness of the base membrane is 3 μm-20 μm, or 3 μm-12 μm.

As an implementation, the base membrane is selected from any one of more of polyethylene, polypropylene, non-woven fabric, aramid fiber, polyvinylidene fluoride, silicon oxide, and aluminum oxide.

As an implementation, a melting point of the first solid-state electrolyte is 50 °C-150 °C, or 50 °C-100 °C.

As an implementation, the first solid-state electrolyte is selected from any one of polyethylene glycol, polyethylene oxide, lithium borohydride, lithium phosphate sulfide, lithium bis(trifluoromethanesulphonyl)imide, Li₇La₃Zr₂O₁₂, and anti-perovskite.

As an implementation, a melting point of a second solid-state electrolyte in the second solid-state electrolyte layer is 200 °C-500 °C, or 250 °C-350 °C.

As an implementation, a thickness of the second solid-state electrolyte layer is 20 μm-50 μm, or 30 μm-40 μm.

As an implementation, the second solid-state electrolyte layer includes a sulfide solid-state electrolyte, and the sulfide solid-state electrolyte is selected from at least one of Li₆PS₅Cl, Li₁₀GeP₂S₁₂, Li₃PS₄, or Li₇P₃S₁₁.

As an implementation, average particle sizes of the above first solid-state electrolyte and second solid-state electrolyte both are 5 μm-20 μm.

As an implementation, a thickness of the above solid-state electrolyte membrane is 20 μm-80 μm.

As an implementation, the thickness of the above solid-state electrolyte membrane is 30 μm-50 μm.

Another aspect of the present disclosure provides a method for preparing the above solid-state electrolyte membrane. The preparation method includes: at S1: first solid-state electrolyte, a first binder, and a first solvent are mixed to obtain a first slurry; and a second solid-state electrolyte, a second binder, and a second solvent are mixed to obtain a second slurry; at S2: the first slurry and the second slurry are respectively coated on two opposite surfaces in a thickness direction of a base membrane, so as to obtain a wet membrane; and at S3: a heat treatment is performed on the wet membrane to obtain a solid-state electrolyte membrane. The heat treatment includes heat pressing, a heat pressing temperature is higher than a melting-point temperature of the first solid-state electrolyte, and is lower than melting-point temperatures of the second solid-state electrolyte and the base membrane.

As an implementation, a mass ratio of the above first solid-state electrolyte to the first binder is (49:1)-(4:1), and/or a mass ratio of the first solid-state electrolyte to the first solvent is (6:4)-(7:5).

As an implementation, a mass ratio of the above second solid-state electrolyte to the second binder is (49:1)-(4:1), and/or a mass ratio of the second solid-state electrolyte to the second solvent is (6:4)-(7:5).

As an implementation, the above first binder and the second binder are each independently selected from at least one of polyacrylic acid, acrylonitrile-butadiene rubber, styrene butadiene rubber, sodium carboxymethyl cellulose, polyvinylidene fluoride, or polyethylene oxide; and the first solvent and the second solvent are each independently selected from at least one of toluene, dichloromethane, 1,2-dimethoxyethane, acetonitrile, chloroform, cyclohexanone, methyl acetate, ethyl acetate, or tetrahydrofuran.

As an implementation, the above mixing operation in S1 further includes: first stirring is performed on the first solid-state electrolyte, the first binder, and the first solvent; and the mixing operation in S2 further includes: second stirring is performed on the second solid-state electrolyte, the second binder, and the second solvent. Rotary speeds of first stirring and second stirring are each independently 1000 r/min-1800 r/min, and the time for first stirring and second stirring is independently 1 h-2 h, respectively.

As an implementation, the process of the above heat treatment is to dry the wet membrane first and then perform heat pressing.

As an implementation, a drying temperature is 60 °C-100 °C, and/or a drying time is 6 h-12 h.

As an implementation, a heat pressing temperature is 65 °C-250 °C, a heat pressing pressure is 1 MPa~30 MPa, and a heat pressing time is 5 min-60 min.

By using the technical solutions of the present disclosure, for the solid-state electrolyte membrane with the above structure and composition, in an aspect, a portion of the first solid-state electrolyte is filled in the porous structure of the base membrane, and in the case where the thickness of the solid electrolyte membrane is constant, the mechanical strength of the solid electrolyte membrane is effectively improved, and a short circuit in a battery caused by punctures is prevented. In another aspect, at least a portion of the first solid-state electrolyte layer can be in direct contact with the second solid-state electrolyte layer through a plurality of holes (e.g., the through holes) of the base membrane, causing the contact between the first solid-state electrolyte and the second solid-state electrolyte to be closer, such that interface impedance is reduced, and lithium ion transmission efficiency is improved. Therefore, through the above plurality of factors, the solid-state electrolyte membrane can take lower impedance and higher energy density into consideration while having excellent mechanical properties, and is adapted to continuous production at the same time, thereby realizing dual goals of high performance and industrialized applications.

### BRIEF DESCRIPTION OF THE DRAWINGS

The drawings, which form a part of the present disclosure, are used to provide a further understanding of the present disclosure. The exemplary embodiments of the present disclosure and the description thereof are used to explain the present disclosure, but do not constitute improper limitations to the present disclosure. In the drawings:

FIG. 1(a) is an Electrochemical Impedance Spectroscopy (EIS) diagram of a solid-state battery corresponding to a solid-state electrolyte membrane before heat pressing according to Comparative embodiment 1 of the present disclosure.

FIG. 1(b) is an EIS diagram of a solid-state battery corresponding to a solid-state electrolyte membrane after heat pressing according to Embodiment 1 of the present disclosure.

FIG. 2 is a test diagram of cycling performance of a full battery using a solid-state electrolyte membrane shown in Embodiment 1 of the present disclosure.

### DETAILED DESCRIPTION OF THE EMBODIMENTS

It is to be noted that the embodiments in the present disclosure and the features in the embodiments may be combined with one another without conflict. The present disclosure will be described below in detail with reference to the drawings and the embodiments.

As analyzed in the Background of the present disclosure, solid-state electrolyte membranes have the problem in the related art of being unable to take battery impedance and energy density into consideration while ensuring the mechanical properties. In order to solve the above problem, the present disclosure provides solid-state electrolyte membrane and preparation method thereof.

A typical implementation of the present disclosure provides a solid-state electrolyte membrane. The solid-state electrolyte membrane includes a first solid-state electrolyte layer, a base membrane containing a porous structure, and a second solid-state electrolyte layer, which are sequentially stacked in a thickness direction of the solid-state electrolyte membrane. At least a portion of first solid-state electrolyte in the first solid-state electrolyte layer is filled in the porous structure of the base membrane, and the porous structure includes a through hole.

For the solid-state electrolyte membrane with the above structure and composition, in an aspect, a portion of the first solid-state electrolyte is filled in the porous structure of the base membrane, and in the case where the thickness of the solid electrolyte membrane is constant, the mechanical strength of the solid electrolyte membrane is effectively improved, and a short circuit in a battery caused by punctures is prevented. In another aspect, at least a portion of the first solid-state electrolyte layer can be in direct contact with the second solid-state electrolyte layer through a plurality of holes (e.g., the through holes) of the base membrane, causing the contact between the first solid-state electrolyte and the second solid-state electrolyte to be closer, such that interface impedance is reduced, and lithium ion transmission efficiency is improved. Therefore, through the above plurality of factors, the solid-state electrolyte membrane can take lower impedance and higher energy density into consideration while having excellent mechanical properties.

Furthermore, the thickness of the solid-state electrolyte membrane may be 20 μm-80 μm, or 30 μm-50 μm. Further, the thickness of the solid-state electrolyte membrane may be 20 μm, 22 μm, 24 μm, 26 μm, 30 μm, 32 μm, 35 μm, 38 μm, 40 μm, 42 μm, 45 μm, 48 μm, 50 μm, 52 μm, 54 μm, 55 μm, 58 μm, 60 μm, 65 μm, 70 μm, 72 μm, 75 μm, or 80 μm, and the thickness of the solid-state electrolyte membrane may definitely be any value within the range of 20 μm-80 μm, and is not described herein again.

In some embodiments of the present disclosure, the above porous structure further includes staggered holes.

In addition to containing the through holes, the porous structure in the base membrane may further include the staggered holes. In a first aspect, the layout of the staggered holes may improve the structure stability of the solid-state electrolyte membrane. By dispersing stress in different directions, the capability of the solid-state electrolyte membrane to resist to external pressure is improved, and the complexity and toughness of the membrane layer are improved, such that stress caused by changes in a volume of a battery during a charging and discharging cycle is relieved, and risks of breakage during processing and use are reduced, thereby improving the cycling stability of the battery and prolonging the service life. In a second aspect, the presence of the staggered holes not only may increase a contact area between the first solid-state electrolyte and second solid-state electrolyte layers, but also can form a more complex ion transmission network. Even if a portion of a path is blocked, lithium ions may still move freely through other paths, thereby maintaining lower impedance and higher ionic conductivity. In a third aspect, during the heat treatment process, the staggered hole structure facilitates the more uniform filling of the first solid-state electrolyte in the pores of the base membrane, so as to increase filling density, such that the solid-state electrolyte membrane can form a more compact and uniform structure after being subjected to the processes of hot melt and solidification, thereby further reducing interface impedance. In a fourth aspect, a staggered hole design in the porous structure can improve the supporting capacity of the membrane while ensuring certain air permeability, which is crucial for the performance of the battery under high rate charging and discharging conditions, thereby ensuring a good balance between ion transmission efficiency and the stability of the solid-state electrolyte membrane.

In some embodiments of the present disclosure, the first solid-state electrolyte accounting for 30 wt %-70 wt % of the total mass of the above first solid-state electrolyte layer is filled in the porous structure of the base membrane.

By controlling the mass proportion of the first solid-state electrolyte filled in the porous structure of the base membrane, a balance between the mechanical strength and the electrochemical performance is realized, and the performance of the solid-state electrolyte membrane is significantly improved, including reducing interface impedance, improving ionic conductivity, increasing energy density, and improving charging and discharging performance. Specifically, in an aspect, by filling the first solid-state electrolyte in the porous structure of the base membrane, the mechanical strength of the solid-state electrolyte may be increased without significantly increasing a total thickness of the solid-state electrolyte. Solid-state electrolyte particles are filled in the pores of the base membrane to form mechanical interlocking, such that the capability of the solid-state electrolyte to resist to external pressure is improved, and the risk of solid-state electrolyte breakage due to mechanical stress during battery manufacturing and use is reduced. In another aspect, the solid-state electrolyte particles are filled in the porous structure, such that a more continuous ion transmission path is formed, and barriers encountered by the lithium ions when passing through the membrane are reduced, thereby improving the ion transmission efficiency.

Furthermore, by controlling a filling ratio of the first solid-state electrolyte, the repeatability and consistency of the membrane during preparation may be improved, which is particularly important for high volume production of solid-state electrolyte membranes and to ensure the performance stability of the battery. Alternatively, the first solid-state electrolyte accounting for 40 wt %-60 wt % of the total mass of the above first solid-state electrolyte layer is filled in the porous structure of the base membrane, the first solid-state electrolyte accounting for 30 wt %, 40 wt %, 42 wt %, 45 wt %, 48 wt %, 50 wt %, 52 wt %, 55 wt %, 60 wt %, 65 wt %, or 70 wt % of the total mass of the above first solid-state electrolyte layer may be filled in the porous structure of the base membrane. Definitely, any value within 40 wt %-60 wt % may also be available, and is not described herein again.

In some embodiments of the present disclosure, mechanical strength of the above solid-state electrolyte membrane is 20 MPa-100 MPa; and/or ionic conductivity of the above solid-state electrolyte membrane is 1×10⁻⁵ S/cm-9×10⁻³ S/cm; and/or impedance of the above solid-state electrolyte membrane is 10Ω-1100Ω.

The solid-state electrolyte membrane having the above mechanical strength has good tolerance, which facilitates resistance to various stresses during battery manufacturing, such as heat pressing, rolling, etc., as well as mechanical stress during battery use. Breakage or deformation of the solid-state electrolyte membrane during manufacturing and use is reduced, and the risk of internal short circuit in the battery and reduction in the service life of the battery is reduced. Moreover, strong enough mechanical properties also cause the battery to adapt to a more complex use environment, thereby improving its overall safety and reliability. The mechanical strength of the above solid-state electrolyte membrane may be 20 MPa-100 MPa. The mechanical strength of the above solid-state electrolyte membrane may specifically be 20 MPa, 25 MPa, 30 MPa, 35 MPa, 40 MPa, 45 MPa, 50 MPa, 51 MPa, 55 MPa, 60 MPa, 65 MPa, 70 MPa, 72 MPa, 73 MPa, 75 MPa, 80 MPa, 81 MPa, 82 MPa, 83 MPa, 85 MPa, 90 MPa, 92 MPa, 95 MPa, or 100 MPa, and may definitely be any value within 20 MPa-100 MPa, and is not described herein again.

The solid-state electrolyte membrane with the above ionic conductivity can effectively promote migration of the lithium ions, which is crucial for the charging and discharging performance of the battery. The high ionic conductivity means that the lithium ions can pass through the solid-state electrolyte membrane more quickly, thereby facilitating improvement of the power density and energy efficiency of the battery. Moreover, the high ionic conductivity further facilitates a reduction in resistance to charge transfer inside the battery, such that the problem of heat generation and capacity decay of the battery during high rate charging and discharging is reduced. The ionic conductivity of the above solid-state electrolyte membrane is 1.0×10⁻⁵ S/cm-9.0×10⁻³ S/cm, or 5.0×10⁻⁵ S/cm-6.0×10⁻³ S/cm, or 5.0×10⁻⁴ S/cm-8.0×10⁻⁴ S/cm. The ionic conductivity of the above solid-state electrolyte membrane may specifically be 1.0×10⁻⁵ S/cm, 2.5×10⁻⁵ S/cm, 5.0×10⁻⁵ S/cm, 1.0×10⁻⁴ S/cm, 2.5×10⁻⁴ S/cm, 5.0×10⁻⁴ S/cm, 5.02×10⁻⁴ S/cm, 5.12×10⁻⁴ S/cm, 5.16×10⁻⁴ S/cm, 5.5×10⁻⁴ S/cm, 5.53×10⁻⁴ S/cm, 6.0×10⁻⁴ S/cm, 6.01×10⁻⁴ S/cm, 6.04×10⁻⁴ S/cm, 6.2×10⁻⁴ S/cm, 6.26×10⁻⁴ S/cm, 6.5×10⁻⁴ S/cm, 6.57×10⁻⁴ S/cm, 7.07×10⁻⁴ S/cm, 7.13×10⁻⁴ S/cm, 8.0×10⁻⁴ S/cm, 8.05×10⁻⁴ S/cm, 9.0×10⁻⁴ S/cm, 1.0×10⁻³ S/cm, 2.5×10⁻³ S/cm, 5.0×10⁻³ S/cm, or 9.0×10⁻³ S/cm, and may definitely be any value within 1.0×10⁻⁵ S/cm-9.0×10⁻³ S/cm, and is not described herein again.

The impedance refers to resistance of the solid-state electrolyte membrane to the passing through of a current during the charging and discharging of the battery. The solid-state electrolyte membrane with the above low impedance means that an energy loss in the battery during charging and discharging is smaller, and efficiency is higher. By optimizing a material and structure of the solid-state electrolyte membrane to reduce its impedance, the electrochemical performance of the battery may be significantly improved, including increasing a charging and discharging speed and cycle life of the battery, and at the same time, the internal heating of the battery during charging and discharging can also be reduced, thereby improving overall safety. The impedance of the above solid-state electrolyte membrane is 10Ω-1100Ω, or 50Ω-600Ω, or 80Ω-432Ω. The impedance of the above solid-state electrolyte membrane may specifically be 10 Ω, 20 Ω, 50 Ω, 80 Ω, 84 Ω, 100 Ω, 101 Ω, 105 Ω, 106 Ω, 107 Ω, 150 Ω, 153 Ω, 200 Ω, 202 Ω, 212 Ω, 215 Ω, 250 Ω, 300 Ω, 309 Ω, 350 Ω, 400 Ω, 432 Ω, 450 Ω, 500 Ω, 550 Ω, 600 Ω, 650 Ω, 700 Ω, 750 Ω, 800 Ω, 850 Ω, 900 Ω, 950 Ω, 1000 Ω, 1050Ω, or 1100Ω, and may definitely be any value within 10Ω-1100Ω, and is not described herein again.

To sum up, the solid-state electrolyte membrane with the above high mechanical strength, high ionic conductivity, and low impedance facilitates improvement of the power density, energy efficiency, and cycling stability of the solid-state battery, and thus is more competitive in high-requirement applications such as electric vehicles, energy storage systems, etc.

In some embodiments of the present disclosure, a melting point of the above base membrane and a melting point of the second solid-state electrolyte in the second solid-state electrolyte layer both are higher than a melting point of the first solid-state electrolyte in the first solid-state electrolyte layer.

The low melting-point characteristic of the first solid-state electrolyte causes the first solid-state electrolyte to be able to be melted during the heat treatment (e.g., a heat pressing stage), flow and be filled in the pores of the base membrane, so as to form a continuous ion conduction network, such that the integrity of the solid-state electrolyte membrane is improved, and the mechanical properties of the solid-state electrolyte membrane are also improved. The base membrane and the second solid-state electrolyte layer remain a solid state during the heat treatment, that is, are not subject to melting and deformation by temperatures, so as to maintain the integrity of its structure, such that a closer interface contact is formed after heat pressing, thereby reducing interface impedance, and improving the transmission efficiency of the lithium ions. Furthermore, the second solid-state electrolyte layer provides an additional ion conduction path, and collaboratively maintains the overall structure stability and ionic conductivity of the solid-state electrolyte membrane together with the base membrane.

The high melting points of the base membrane and the second solid-state electrolyte also mean that the base membrane and the second solid-state electrolyte can remain stable within a temperature range of battery operation, phase transition or performance degradation does not occur due to temperature changes, and this is important for maintaining the long-term electrochemical stability and cycling performance of the battery.

To sum up, by setting the melting points of the base membrane and the second solid-state electrolyte to be higher than the melting point of the first solid-state electrolyte, the present disclosure can prepare the solid-state electrolyte membrane having high heat stability, low interface impedance, and high mechanical strength, and adapted to continuous production, and these characteristics act together on improving the overall performance of the solid-state battery.

In some embodiments of the present disclosure, a pore diameter of the above through hole is 25 μm-150 μm, or 30 μm-50 μm; and/or a gap between the 10 μm-200 μm, or 10 μm-50 μm; an air permeability rate of the base membrane is 70%-80%; and/or a through hole rate of the base membrane is 50%-60%; and porosity of the base membrane is 70%-90%.

By controlling the pore diameter of the through hole within the range, the base membrane has effectively-transmitted lithium ions, and also has a microstructure with enough supporting strength. The through hole with the pore diameter of 30 μm-50 μm further ensures the high efficiency of an ion transmission path, and simultaneously limits the risk of a reduction in mechanical strength caused by excessive pore diameter. The pore diameter of the through hole may be 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 105 μm, 110 μm, 115 μm, 120 μm, 125 μm, 130 μm, 135 μm, 140 μm, 145 μm, or 150 μm, and the pore diameter of the through hole may definitely be any value within 25 μm-150 μm, and is not described herein again.

A small gap between the adjacent through holes facilitates the increasing of the contact area between the first solid-state electrolyte layer and the second solid-state electrolyte layer, thereby promoting ion conduction, and reducing interface impedance. The gap between the adjacent through holes being 10 μm-50 μm more facilitates formation of a denser lithium ion transmission network, and simultaneously reduces the risk of material crowding and porosity reduction due to a too small gap. The gap between the adjacent through holes may be 10 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 105 μm, 110 μm, 115 μm, 120 μm, 125 μm, 130 μm, 135 μm, 140 μm, 145 μm, 150 μm, 155 μm, 160 μm, 165 μm, 170 μm, 175 μm, 180 μm, 185 μm, 190 μm, 195 μm, or 200 μm, and the gap between the adjacent through holes may definitely be any value within 10 μm-200 μm, and is not described herein again.

A high air permeability rate means that the base membrane has high pore connectivity, facilitating the quick migration of the lithium ion, thereby improving the power density and efficiency of the battery. Furthermore, by maintaining the air permeability rate within the range, the base membrane also has enough supporting strength while providing the lithium ion transmission path. The air permeability rate of the base membrane may be 70%, 71%, 72%, 73%, 74%, 75%, 76%, 77%, 78%, 79%, or 80%, and the air permeability rate may definitely be any value within 70%-80%, and is not described herein again.

The setting of the through hole rate facilitates the maintaining of the structure stability of the base membrane and the uniform distribution of the pores, such that the lithium ions are uniformly transmitted between cathode and anode, so as to reduce the risk of formation of a localized high impedance region, thereby improving the overall performance of the battery. The through hole rate of the base membrane may be 50%, 51%, 52%, 53%, 54%, 55%, 56%, 57%, 58%, 59%, or 60%, and the through hole rate of the base membrane may definitely be any value within 50%-60%, and is not described herein again.

The high porosity facilitates formation of sufficient lithium ion transmission paths in the base membrane, but also needs to ensure that the mechanical strength is not affected. With in the range, the base membrane can provide sufficient pores to promote the quick migration of the lithium ions, and at the same time, the mechanical strength is improved by filling the first solid-state electrolyte layer. The porosity of the base membrane may be 70%, 71%, 72%, 73%, 74%, 75%, 76%, 77%, 78%, 79%, 80%, 81%, 82%, 83%, 84%, 85%, 86%, 87%, 88%, 89%, or 90%, and the porosity of the base membrane may definitely be any value within 70%-90%, and is not described herein again.

By carefully adjusting the above parameters of the above base membrane, the electrochemical performance of the solid-state electrolyte membrane is optimized while the solid-state electrolyte membrane has enough mechanical strength.

In some embodiments of the present disclosure, a melting point of the base membrane is 200 °C-600 °C, or 300 °C-400 °C.

By controlling the melting point of the above base membrane, the risk of thermal deformation of the base membrane is reduced, the mechanical strength of the base membrane is improved, the flow and filling of the low-melting-point solid-state electrolyte are promoted at the same time, interface impedance is reduced, lithium ion transmission is optimized, and the structure stability of the battery under a high temperature production process is improved, thereby improving the overall electrochemical performance and safety of the battery. The melting point of the base membrane may be 200 °C, 220 °C, 250 °C, 270 °C, 300 °C, 320 °C, 350 °C, 400 °C, 420 °C, 450 °C, 500 °C, 520 °C, 550 °C, or 600 °C, and the melting point of the base membrane may definitely be any value within the range of 200 °C-600 °C, and is not described herein again.

In some embodiments of the present disclosure, a thickness of the base membrane is 3 μm-20 μm, or 3 μm-12 μm.

In an aspect, the base membrane with the above thickness meets the lightness and thinness of the solid-state electrolyte membrane to reduce the overall weight of the battery, thereby increasing energy density. In another aspect, the base membrane with the above thickness plays a role in supporting the solid-state electrolyte membrane, and an enough thickness maintains the mechanical stability of the solid-state electrolyte membrane, thereby reducing the risk of a short circuit in the battery. The thickness of the base membrane may be 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, or 20 μm, and the thickness of the base membrane may definitely be any value within 3 μm-20 μm, and is not described herein again.

In some embodiments of the present disclosure, the base membrane is selected from any one of more of polyethylene, polypropylene, non-woven fabric, aramid fiber, polyvinylidene fluoride, silicon oxide, and aluminum oxide.

The material of the above base membrane is selected based on compatibility with the solid-state electrolyte, a melting point, a cost, and the adaptability of a manufacturing process. Different base membrane materials provide different mechanical strength and chemical properties. For example, the polyethylene and the polypropylene have good chemical stability and mechanical strength, and the silicon oxide and the aluminum oxide provide high temperature stability and good porosity.

In some embodiments of the present disclosure, a melting point of the first solid-state electrolyte is 50 °C-150 °C, or 50 °C-100 °C.

For the first solid-state electrolyte with the above melting point, the first solid-state electrolyte may be melted under the mild heat treatment condition, and is filled in the pores of the base membrane, such that interlayer bonding of the solid-state electrolyte membrane is enhanced, impedance is reduced, lithium ion conduction efficiency is improved, and structural integrity is ensured, thereby optimizing battery performance and production compatibility. The melting point of the first solid-state electrolyte may be 50 °C, 55 °C, 60 °C, 65 °C, 70 °C, 75 °C, 80 °C, 85 °C, 90 °C, 95 °C, 100 °C, 105 °C, 110 °C, 115 °C, 120 °C, 125 °C, 130 °C, 135 °C, 140 °C, 145 °C, or 150 °C, and the melting point of the first solid-state electrolyte may definitely be any value within 50 °C-150 °C, and is not described herein again.

In some embodiments of the present disclosure, the above first solid-state electrolyte is selected from any one of polyethylene glycol, polyethylene oxide, lithium borohydride, lithium phosphate sulfide, lithium bis(trifluoromethanesulphonyl)imide, Li₇La₃Zr₂O₁₂, and anti-perovskite.

By selecting a particular material for the first solid-state electrolyte, such as the polyethylene glycol, the polyethylene oxide, etc., due to its low melting-point characteristic, the first solid-state electrolyte flows and is filled in the pores of the base membrane during the heat treatment, such that the mechanical strength of the solid-state electrolyte membrane is improved, low impedance is maintained at the same time, the efficient conduction of the lithium ions is promoted, the performance of the battery is optimized, and the first solid-state electrolyte is especially suitable for continuous production, thereby realizing dual goals of high performance and industrialized applications.

In some embodiments of the present disclosure, a melting point of a second solid-state electrolyte in the second solid-state electrolyte layer is 200 °C-500 °C, or 250 °C-350 °C.

The second solid-state electrolyte with the above melting point has a more stable structure at a battery processing temperature, such that the risk of melting and deformation is reduced, complementarity is formed with the low-melting-point first solid-state electrolyte layer at the same time, the mechanical properties of the entire solid-state electrolyte membrane are improved, and high ionic conductivity is maintained, thereby improving the safety and energy density of the battery. The melting point of the above second solid-state electrolyte may be 200 °C, 210 °C, 220 °C, 230 °C, 240 °C, 250 °C, 260 °C, 270 °C, 280 °C, 290 °C, 300 °C, 310 °C, 320 °C, 330 °C, 340 °C, 350 °C, 360 °C, 370 °C, 380 °C, 390 °C, 400 °C, 410 °C, 420 °C, 430 °C, 440 °C, 450 °C, 460 °C, 470 °C, 480 °C, 490 °C, or 500 °C, and the melting point of the second solid-state electrolyte may definitely be any value within 200 °C-500 °C, and is not described herein again.

In some embodiments of the present disclosure, a thickness of the second solid-state electrolyte layer is 20 μm-50 μm, or 30 μm-40 μm.

The thickness of the second solid-state electrolyte layer facilitates its synergy with the thickness of the first solid-state electrolyte layer, such that the total thickness of the solid-state electrolyte membrane is controlled within a certain range. Furthermore, a necessary ion conduction channel is provided, good electrochemical performance is maintained, the impedance and thickness of the battery are not increased excessively, energy density and safety are balanced, and thus, the second solid-state electrolyte layer is suitable for high efficiency battery production and application. The thickness of the second solid-state electrolyte layer may be 20 μm, 22 μm, 25 μm, 28 μm, 30 μm, 32 μm, 38 μm, 40 μm, 45 μm, or 50 μm, and the thickness of the second solid-state electrolyte layer may definitely be any value within 20 μm-50 μm, and is not described herein again.

In some embodiments of the present disclosure, the above second solid-state electrolyte layer includes a sulfide solid-state electrolyte, and the sulfide solid-state electrolyte is selected from at least one of Li₆PS₅Cl, Li₁₀GeP₂S₁₂, Li₃PS₄, or Li₇P₃S₁₁.

The inherent characteristic of a sulfide facilitates formation of a compact layer, and improvement of isolation between electrodes, thereby ensuring the safety and performance consistency of the battery. By selecting the sulfide such as Li₆PS₅Cl, Li₁₀GeP₂S₁₂, etc. as the second solid-state electrolyte, the charging and discharging efficiency and cycle life of the battery are significantly improved because of its high ionic conductivity and chemical stability.

In some embodiments of the present disclosure, average particle sizes of the above first solid-state electrolyte and second solid-state electrolyte are each independently 5 μm-20 μm.

The appropriate average particle sizes of the first solid-state electrolyte and second solid-state electrolyte facilitate formation of continuous and stable lithium ion conduction paths, such that the ionic conductivity of the solid-state electrolyte membrane is improved, thereby improving the charging and discharging performance of the battery. The average particle sizes of the above first solid-state electrolyte and second solid-state electrolyte, in an aspect, facilitate a close contact between the first solid-state electrolyte layer and the second solid-state electrolyte layer, such that impedance at an interface is reduced, and efficient ion transmission is ensured, thereby increasing the energy density of the battery. In another aspect, during a coating process, particles of 5 μm-20 μm easily form a uniform coating, such that the risk of the performance consistency of the battery affected by non-uniform distribution due to excessively-large particles is reduced. Furthermore, in the heat treatment stage, the appropriate average particle sizes of the first solid-state electrolyte and second solid-state electrolyte facilitate uniform heating, such that the controllability of melting and filling processes is improved, and the risk of excessive flow caused by incomplete or insufficient melting due to excessively-large particles is reduced. The average particle sizes of the above first solid-state electrolyte and second solid-state electrolyte may be each independently 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, or 20 μm, and the average particle sizes of the first solid-state electrolyte and second solid-state electrolyte may definitely be each independently any value within 5 μm-20 μm, and is not described herein again.

In some embodiments of the present disclosure, the thickness of the solid-state electrolyte membrane is 20 μm-80 μm, or 30 μm-50 μm.

The thickness of the solid-state electrolyte membrane is a sum of the thickness of the base membrane, the thickness of the first solid-state electrolyte layer, and the thickness of the second solid-state electrolyte layer. The thickness of the solid-state electrolyte membrane is directly related to the mechanical strength and ion transmission efficiency of the solid-state electrolyte membrane. If the solid-state electrolyte membrane is too thick, the impedance of the solid-state electrolyte membrane may be increased, and energy density is reduced; and if the solid-state electrolyte membrane is too thin, the mechanical strength of the solid-state electrolyte membrane may be reduced, resulting in a short circuit in the battery. An appropriate membrane thickness may optimize the mechanical property, ionic conductivity, and energy density of the battery. Specifically, the thickness of the solid-state electrolyte membrane being selected to be 30 μm-50 μm facilitates more full matching of a continuous production operation during manufacturing and ensuring of the mechanical property of the solid-state electrolyte membrane while the battery realizes high energy density of 354 wh/kg. Further, the energy density of the battery may reach 200 Wh/kg-354 Wh/kg. For example, the energy density of the battery may be 204 Wh/kg, 224 Wh/kg, 226 Wh/kg, 227 Wh/kg, 242 Wh/kg, 279 Wh/kg, 281 Wh/kg, 283 Wh/kg, 288 Wh/kg, 310 Wh/kg, or 354 Wh/kg. The thickness of the solid-state electrolyte membrane may be 20 μm, 22 μm, 25 μm, 30 μm, 32 μm, 35 μm, 38 μm, 40 μm, 42 μm, 45 μm, 48 μm, 50 μm, 52 μm, 55 μm, 58 μm, 60 μm, 62 μm, 65 μm, 68 μm, 70 μm, 72 μm, 75 μm, or 80 μm, and the thickness of the solid-state electrolyte membrane may definitely be any value within the range of 20 μm-80 μm, and is not described herein again.

Another typical implementation of the present disclosure provides a method for preparing the above solid-state electrolyte membrane. The preparation method includes: at S1: first solid-state electrolyte, a first binder, and a first solvent are mixed to obtain a first slurry; and a second solid-state electrolyte, a second binder, and a second solvent are mixed to obtain a second slurry; at S2: the first slurry and the second slurry are respectively coated on two opposite surfaces in a thickness direction of a base membrane, so as to obtain a wet membrane; and at S3: a heat treatment is performed on the wet membrane to obtain a solid-state electrolyte membrane. The heat treatment includes heat pressing, a heat pressing temperature is higher than a melting-point temperature of the first solid-state electrolyte, and is lower than melting-point temperatures of the second solid-state electrolyte and the base membrane.

The key of the method for preparing the above solid-state electrolyte membrane is the controlling of heat treatment conditions. The heat treatment is to dry the wet membrane first and then perform heat pressing. The integrity and performance optimization of a membrane structure are ensured by controlling the heat pressing temperature of the heat treatment to be higher than the melting-point temperature of the first solid-state electrolyte and controlling the heat pressing temperature of the heat treatment to be lower than the melting-point temperatures of the second solid-state electrolyte and the base membrane at the same time.

Specifically, through the controlling of the heat pressing temperature, the process of heat pressing can promote hot melt in the first solid-state electrolyte and cause a portion of the first solid-state electrolyte to be filled in the porous structure of the base membrane, so as to form a more continuous structure, such that the mechanical strength of the solid-state electrolyte membrane is increased, and solvents introduced during slurry preparation are removed, thereby ensuring the compactness and purity of the solid-state electrolyte membrane. The first solid-state electrolyte layer is in contact with the second solid-state electrolyte layer, so as to reduce an interface impedance of between the base membrane and the solid-state electrolyte layer.

Furthermore, the heat pressing process can also adjust a microstructure of the solid-state electrolyte membrane, reduce the interface impedance, and improve electrical performance.

For the solid-state electrolyte membrane obtained by the above preparation method, in an aspect, in the case where the thickness of the solid electrolyte membrane is constant, the mechanical strength of the solid electrolyte membrane is effectively improved, and a short circuit in a battery caused by punctures is prevented. In another aspect, the first solid-state electrolyte layer can be in direct contact with the second solid-state electrolyte layer through the through hole (via hole) of the base membrane, causing the contact between the first solid-state electrolyte and the second solid-state electrolyte to be more closer, such that interface impedance is reduced, and lithium ion transmission efficiency is improved. Therefore, through the above plurality of factors, the solid-state electrolyte membrane can take lower impedance and higher energy density into consideration while having excellent mechanical properties.

In some embodiments of the present disclosure, a mass ratio of the above first solid-state electrolyte to the first binder is (49:1)-(4:1), and a mass ratio of the first solid-state electrolyte to the first solvent is (6:4)-(7:5). The first binder is selected from at least one of polyacrylic acid, acrylonitrile-butadiene rubber, styrene butadiene rubber, sodium carboxymethyl cellulose, polyvinylidene fluoride, or polyethylene oxide; and the first solvent is selected from at least one of toluene, dichloromethane, 1,2-dimethoxyethane, acetonitrile, chloroform, cyclohexanone, methyl acetate, ethyl acetate, or tetrahydrofuran.

The first binder such as the polyacrylic acid, the sodium carboxymethyl cellulose, the polyvinylidene fluoride, etc. facilitates improvement of a binding force between solid-state electrolyte particles and the base membrane. The first solvent such as toluene, dichloromethane, etc. plays a role in dispersing the solid-state electrolyte and the binder during the slurry preparation process, so as to coat the first slurry on the base membrane. An appropriate combination of the first binder and the type of the first solvent, mass ratio of the first solid-state electrolyte to the first binder, and mass ratio of the first solid-state electrolyte to the first solvent facilitate the achieving of a cooperative interaction effect among the first solid-state electrolyte, the first binder, and the first solvent, so as to obtain the uniformly-mixed first slurry, such that the first solid-state electrolyte layer formed on the base membrane is distributed more uniformly, thereby further improving the structure stability of the solid-state electrolyte membrane. Moreover, by selecting the above type of the first solvent, the first solvent is effectively removed during the heat treatment without affecting the structure of the solid-state electrolyte membrane.

In some embodiments of the present disclosure, a mass ratio of the above second solid-state electrolyte to the second binder is (49:1)-(4:1), and a mass ratio of the second solid-state electrolyte to the second solvent is (6:4)-(7:5). The second binder is selected from at least one of polyacrylic acid, acrylonitrile-butadiene rubber, styrene butadiene rubber, sodium carboxymethyl cellulose, polyvinylidene fluoride, or polyethylene oxide; and the second solvent is selected from at least one of toluene, dichloromethane, 1,2-dimethoxyethane, acetonitrile, chloroform, cyclohexanone, methyl acetate, ethyl acetate, or tetrahydrofuran.

The second binder such as the polyacrylic acid, the sodium carboxymethyl cellulose, the polyvinylidene fluoride, etc. facilitates improvement of a binding force between solid-state electrolyte particles and the base membrane. The second solvent such as toluene, dichloromethane, etc. plays a role in dispersing the solid-state electrolyte and the binder during the slurry preparation process, so as to coat the second slurry on the base membrane. An appropriate combination of the second binder and the type of the second solvent, mass ratio of the second solid-state electrolyte to the second binder, and mass ratio of the second solid-state electrolyte to the second solvent facilitate the achieving of a cooperative interaction effect among the second solid-state electrolyte, the second binder, and the second solvent, so as to obtain the uniformly-mixed second slurry, such that the second solid-state electrolyte layer formed on the base membrane is distributed more uniformly, thereby further improving the structure stability of the solid-state electrolyte membrane. Moreover, by selecting the above type of the second solvent, the second solvent is effectively removed during the heat treatment without affecting the structure of the solid-state electrolyte membrane.

In some embodiments of the present disclosure, the above mixing operation in S1 further includes: first stirring is performed on the first solid-state electrolyte, the first binder, and the first solvent; and the mixing operation in S2 further includes: second stirring is performed on the second solid-state electrolyte, the second binder, and the second solvent. Rotary speeds of first stirring and second stirring are each independently 1000 r/min-1800 r/min, and the time for first stirring and second stirring is independently 1 h-2 h, respectively.

In an aspect, the above set stirring rotary speed and time facilitate full dispersion of the first binder (second binder), first solvent (second solvent), and first solid-state electrolyte (second solid-state electrolyte), so as to form the uniform first slurry (second slurry). This step is crucial for the uniformity of subsequent coating and the microstructure of the solid-state electrolyte membrane. If the stirring rotary speed is insufficient, agglomeration of solid-state electrolyte powder in the slurry may be caused, affecting the consistency of the coating and the performance of the membrane. In another aspect, the above stirring rotary speed and time facilitate the refining of the solid-state electrolyte particles, causing the particles to be more uniform and have decreased particle sizes, such that the particles during the heat treatment are better filled in the porous structure of the base membrane, thereby improving the mechanical strength and conductivity of the solid-state electrolyte membrane. If the stirring time is insufficient, the time for contacting and mixing slurry components may be fully prolonged, so as to form a stable complex structure. When the solid-state electrolyte layer is in contact with the base membrane or another solid-state electrolyte layer, such stable complex structure may reduce the impedance at an interface, thereby improving the transmission efficiency of lithium ions.

The rotary speeds for the above first stirring and second stirring each may be independently 1000 r/min, 1100 r/min, 1200 r/min, 1300 r/min, 1400 r/min, 1500 r/min, 1600 r/min, 1700 r/min, or 1800 r/min, and definitely, the rotary speeds for the above first stirring and second stirring each may be independently any one of point values within 1000 r/min-1800 r/min, and are not described herein again. The time for the first stirring and second stirring each may be independently 0.2 h, 0.3 h, 0.4 h, 0.5 h, 0.6 h, 0.7 h, 0.8 h, 0.9 h, or 1 h, and definitely, the time for the first stirring and second stirring each may be independently any one of point values within 0.2 h-1 h, and are not described herein again.

Furthermore, the appropriate stirring speed and time can effectively remove air bubbles in the slurry, reduce the defects in the solid-state electrolyte membrane, and ensure the compactness and consistency of the membrane, which have a direct impact on the performance and service life of a battery.

As an implementation, in S1, the first binder (second binder) and the first solvent (second solvent) are added to a slurry preparation tank together, the first binder (second binder) and the first solvent (second solvent) are uniformly dispersed first, then the first solid-state electrolyte (second solid-state electrolyte) is added to the slurry preparation tank, and the mixture is stirred for uniform dispersion to a maximum extent, so as to obtain the uniform first slurry and second slurry, respectively. As an implementation, in the slurry preparation process of S1, a single material addition time does not exceed 3 min, and the number of times for material addition is 3-10.

As an implementation, the base membrane in S2 contains a through hole structure, and the through hole structure may be formed through penetration of heated rolling needles. That is, the through hole structure (via hole) may be formed by performing a heated rolling needle penetration operation on a common base membrane. A size of a penetrated hole is adjusted by adjusting a height of a roller. A punching position is adjusted by adjusting a base plate. A heating temperature is debugged according to specific common materials. Thus, the single through hole with the pore diameter of 25 μm-150 μm is obtained, and a gap between the adjacent through holes is 10 μm-200 μm, thereby improving ion transmission efficiency to a maximum extent.

The above holes increase the porosity of the base membrane in a physical manner, such that ion migration is promoted, and the mechanical property of the base membrane is also adjusted at the same time.

In some embodiments of the present disclosure, the process of the above heat treatment is to dry the wet membrane first and then perform heat pressing. A drying temperature is 60 °C-100 °C, and a drying time is 6 h-12 h; and/or a heat pressing temperature is 65 °C-250 °C, a heat pressing pressure is 20 T-60 T, and a heat pressing time is 5 min-60 min.

The presence of the solvent may reduce the mechanical strength and electrical performance of the membrane. Drying is mainly intended to remove the solvent introduced in S1. A specific drying temperature is determined according to a type of the solvent used, so as to effectively remove the solvent in the wet membrane.

In an aspect, the controlling of the above drying temperature and time is to effectively remove the solvent introduced in S1, such that the structure stability of the obtained solid-state electrolyte membrane is improved, and the risk of deformation or damage to the structure of the solid-state electrolyte membrane caused by residual solvents is reduced. In another aspect, controlling the above drying temperature and time, helps to reduce the risk that excessive heat treatment at high temperatures may cause the solid electrolyte to denature and affect its ionic conductivity. The drying temperature may be 60 °C, 65 °C, 70 °C, 75 °C, 80 °C, 85 °C, 90 °C, 95 °C, or 100 °C, and the drying temperature may definitely be any one of point values within 60 °C-100 °C, and is not described herein again. The drying time may be 6 h, 6.5 h, 7 h, 7.5 h, 8 h, 8.5 h, 9 h, 9.5 h, 10 h, 10.5 h, 11 h, 11.5 h, or 12 h, and the drying time may definitely be any one of point values within 6 h-12 h, and is not described herein again. The heat pressing temperature may be 65 °C, 70 °C, 75 °C, 80 °C, 90 °C, 100 °C, 110 °C, 120 °C, 130 °C, 140 °C, 150 °C, 160 °C, 170 °C, 180 °C, 190 °C, 200 °C, 210 °C, 220 °C, 230 °C, 240 °C, or 250 °C, and the heat pressing temperature may definitely be any one of point values within 65 °C-250 °C, and is not described herein again. The heat pressing pressure may be 1 MPa, 5 MPa, 10 MPa, 15 MPa, 20 MPa, 25 MPa, or 30 MPa, and the heat pressing pressure may definitely be any one of point values within 1 MPa~30 MPa, and is not described herein again. The heat pressing time may be 5 min, 10 min, 15 min, 20 min, 25 min, 30 min, 35 min, 40 min, 45 min, 50 min, 55 min, or 60 min, and the heat pressing time may definitely be any one of point values within 5 min-60 min, and is not described herein again.

The selection of the heat pressing temperature ensures that hot melt occurs in the first solid-state electrolyte, but the base membrane and the second solid-state electrolyte are not thermally melted, such that the low-melting-point first solid-state electrolyte layer can be melted, and flows to fill in the pores of the base membrane. Therefore, the mechanical strength of the solid-state electrolyte membrane is increased, the puncture resistance of the solid-state electrolyte membrane is improved, and the risk of a short circuit is reduced. Moreover, a continuous ion conduction network is formed, and the ionic conductivity of the solid-state electrolyte membrane is improved. The selection of the above heat pressing temperature facilitates a closer contact between the first solid-state electrolyte layer and the second solid-state electrolyte layer during heat pressing, such that interface impedance is reduced, and the transmission efficiency of the lithium ions in the membrane is improved. Through the selection and cooperation of the above heat pressing pressure and heat pressing time, the microstructure of the solid-state electrolyte membrane is optimized, including more uniform distribution of particles, and improvement of the compactness of the solid-state electrolyte membrane, and these all facilitate improvement of the overall performance of the solid-state electrolyte. Furthermore, an operation mode of heat pressing is selected from any one or more of a flat-bed integral heat pressing mode, an airbag type heat pressing mode, and a plate heat pressing mode.

The above heat treatment process ensures that the solid-state electrolyte membrane has enough mechanical strength to adapt to various pressure conditions during battery manufacturing, and also ensures that the solid-state electrolyte membrane has low impedance and high ionic conductivity, thereby significantly improving the charging and discharging efficiency and cycling performance of the battery.

The present disclosure is further described in detail below with reference to specific embodiments, and the embodiments cannot be construed as limiting the scope of protection claimed in the present disclosure.

### Embodiment 1

At S1, slurry preparation: 0.70 g of a Polyethylene Oxide (PEO) solid-state electrolyte, 0.07 g of a polyacrylic acid binder, and 0.50 g of an acetonitrile solvent were mixed and then stirred, a stirring rotary speed was 1000 r/min, a stirring time was 1 h, and a first slurry was obtained; and 0.70 g of a Li10GeP2S12 sulfide solid-state electrolyte, 0.07 g of the polyacrylic acid binder, and 0.50 g of the acetonitrile solvent were mixed and then stirred, a stirring rotary speed was 1000 r/min, a stirring time was 0.5 h, and a second slurry was obtained.

At S2, coating: an aramid base membrane was placed in a mechanical punching device, the aramid base membrane was punched to obtain through holes with a pore diameter of 65 μm, a gap between the through holes was 100 μm, an air permeability rate of the aramid base membrane was 60%, a through hole rate of the aramid base membrane was 70%, the porosity of the aramid base membrane was 80%, and the punched membrane was dried for 4 h at 60 °C by being placed in an oven in a glove box or a vacuum oven; and then, a 80 μm scraper was used to respectively coat the first slurry and the second slurry on a surface in a thickness direction of the base membrane, and partial evaporation of a solvent was waited in a room temperature state, so as to obtain a wet membrane having a first solid-state electrolyte layer and a second solid-state electrolyte layer, where a thickness of the aramid base membrane was 12 μm, and a melting point was 500 °C; a thickness of the coated first solid-state electrolyte layer was 20 μm, and a melting point was 60 °C; and a thickness of the coated second solid-state electrolyte layer was 20 μm, and a melting point was 200 °C.

At S3, heat treatment: the wet membrane was transferred to the vacuum oven for drying, a drying temperature was 60 °C, a drying time was 12 h, the solvent was ensured to be removed, the dried diaphragm was cut into a fixed size and subjected to a hydraulic treatment first, after hydraulic pressure ended, in order to prevent the sulfide solid-state electrolyte from being in contact with water in air, vacuum sealing was performed, then the membrane was transferred to a flat-bed press for a heat pressing treatment, then complete sealing was performed, and the heat pressing treatment was then performed for 20 min at 80 °C and 20 MPa to obtain a solid-state electrolyte membrane, where a thickness of the solid-state electrolyte membrane after heat pressing was 32 μm, and first solid-state electrolyte accounting for 50 wt % of the total mass of the first solid-state electrolyte layer was filled in a porous structure of the aramid base membrane.

### Embodiment 2

Difference between Embodiment 2 and Embodiment 1 lied in that, in S2, the thickness of the second solid-state electrolyte layer was 100 μm, the aramid base membrane was punched to obtain the through holes with a pore diameter of 130 μm, the gap between the through holes was 10 μm, the air permeability rate of the aramid base membrane was 70%, the through hole rate of the aramid base membrane was 70%, the porosity of the aramid base membrane was 80%, and the solid-state electrolyte membrane was finally obtained, where the first solid-state electrolyte accounting for 40 wt % of the total mass of the first solid-state electrolyte layer was filled in the porous structure of the aramid base membrane.

### Embodiment 3

Difference between Embodiment 3 and Embodiment 1 lied in that, in S2, the thickness of the second solid-state electrolyte layer was 100 μm, the aramid base membrane was punched to obtain the through holes with a pore diameter of 130 μm, the gap between the through holes was 10 μm, the air permeability rate of the aramid base membrane was 80%, the through hole rate of the aramid base membrane was 70%, the porosity of the aramid base membrane was 80%, and the solid-state electrolyte membrane was finally obtained, where the first solid-state electrolyte accounting for 60 wt % of the total mass of the first solid-state electrolyte layer was filled in the porous structure of the aramid base membrane.

### Embodiment 4

Difference between Embodiment 4 and Embodiment 1 lied in that, in S2, the thickness of the second solid-state electrolyte layer was 100 μm, the aramid base membrane was punched to obtain the through holes with a pore diameter of 130 μm, the gap between the through holes was 10 μm, the air permeability rate of the aramid base membrane was 70%, the through hole rate of the aramid base membrane was 60%, the porosity of the aramid base membrane was 70%, and the solid-state electrolyte membrane was finally obtained, where the first solid-state electrolyte accounting for 30 wt % of the total mass of the first solid-state electrolyte layer was filled in the porous structure of the aramid base membrane.

### Embodiment 5

Difference between Embodiment 5 and Embodiment 1 lied in that, in S2, the thickness of the second solid-state electrolyte layer was 100 μm, the aramid base membrane was punched to obtain the through holes with a pore diameter of 130 μm, the gap between the through holes was 10 μm, the air permeability rate of the aramid base membrane was 80%, the through hole rate of the aramid base membrane was 80%, the porosity of the aramid base membrane was 90%, and the solid-state electrolyte membrane was finally obtained, where the first solid-state electrolyte accounting for 70 wt % of the total mass of the first solid-state electrolyte layer was filled in the porous structure of the aramid base membrane.

### Embodiment 6

Difference between Embodiment 6 and Embodiment 1 lied in that, in S1, a first binder was a styrene butadiene rubber binder, a first solvent was toluene, a mass ratio of the first solid-state electrolyte to the first binder was 49:1, and a mass ratio of the first solid-state electrolyte to the first solvent was 6:4. A second binder was an acrylonitrile-butadiene rubber binder, a second solvent was toluene, a mass ratio of the second solid-state electrolyte to the second binder was 49:1, and a mass ratio of the second solid-state electrolyte to the second solvent was 6:4. A melting point of the aramid base membrane was 500 °C, and a thickness was 12 μm. The first solid-state electrolyte was PEO solid-state electrolyte-LiFSI composite electrolyte, a melting point of the corresponding first solid-state electrolyte layer was 50 °C, and a thickness of the first solid-state electrolyte layer was 80 μm. A second solid-state electrolyte was Li₇P₃S₁₁, and a melting point of the corresponding second solid-state electrolyte layer was 350 °C.

In S3, a temperature for the heat pressing treatment was 65 °C, and the solid-state electrolyte membrane was finally obtained, with a thickness being 30 μm.

### Embodiment 7

Difference between Embodiment 7 and Embodiment 1 lied in that, in S1, a first binder was a styrene butadiene rubber binder, a first solvent was toluene, a mass ratio of the first solid-state electrolyte to the first binder was 4:1, and a mass ratio of the first solid-state electrolyte to the first solvent was 7:3. A second binder was an acrylonitrile-butadiene rubber binder, a second solvent was toluene, a mass ratio of the second solid-state electrolyte to the second binder was 4:1, and a mass ratio of the second solid-state electrolyte to the second solvent was 7:3. A melting point of the aramid base membrane was 500 °C, and a thickness was 12 μm. The first solid-state electrolyte was a PVDF copolymer, the melting point of the corresponding first solid-state electrolyte layer was 150 °C, and the thickness of the first solid-state electrolyte layer was 80 μm. The second solid-state electrolyte was Li₁₀GeP₂S₁₂, and the melting point of the corresponding second solid-state electrolyte layer was 500 °C.

In S3, a temperature for the heat pressing treatment was 160 °C, and the solid-state electrolyte membrane was finally obtained, with a thickness being 40 μm.

### Embodiment 8

A difference between Embodiment 8 and Embodiment 1 lied in that, in S3, the temperature for the heat pressing treatment was 180 °C, and the solid-state electrolyte membrane was finally obtained.

### Embodiment 9

A difference between Embodiment 9 and Embodiment 1 lied in that, in S3, the temperature for the heat pressing treatment was 190 °C, and the solid-state electrolyte membrane was finally obtained.

### Embodiment 10

Difference between Embodiment 10 and Embodiment 1 lied in that, in S2, coating thicknesses of the first solid-state electrolyte layer and second solid-state electrolyte layer both were 20 μm; and in S3, the heat pressing treatment was performed for 30 min at 80 °C and 20 MPa to finally obtain the solid-state electrolyte membrane, with the thickness being 20 μm.

### Embodiment 11

Difference between Embodiment 11 and Embodiment 1 lied in that, in S2, coating thicknesses of the first solid-state electrolyte layer and second solid-state electrolyte layer both were 80 μm; and in S3, the heat pressing treatment was performed for 30 min at 80 °C and 13 MPa to finally obtain the solid-state electrolyte membrane, with the thickness being 80 μm.

### Embodiment 12

Difference between Embodiment 12 and Embodiment 1 lied in that, in S2, coating thicknesses of the first solid-state electrolyte layer and second solid-state electrolyte layer both were 15 μm; and in S3, the heat pressing treatment was performed for 30 min at 80 °C and 27 MPa, and the thickness of the solid-state electrolyte membrane was 15 μm.

### Comparative Embodiment 1

A difference between Comparative embodiment 1 and Embodiment 1 lied in that, in S3, the heat pressing treatment was not performed, and the solid-state electrolyte membrane was finally obtained.

### Comparative Embodiment 2

A difference between Comparative embodiment 2 and Embodiment 1 lied in that, in S3, the temperature for the heat pressing treatment was 40 °C, and the solid-state electrolyte membrane was finally obtained.

### Comparative Embodiment 3

A difference between Comparative embodiment 3 and Embodiment 1 lied in that, in S1, there were no pores in the aramid base membrane, that is, the porosity was 0, and the solid-state electrolyte membrane was finally obtained.

### Performance Test:

Mechanical strength of solid-state electrolyte membrane: its tensile strength was tested by using the ASTM D882 standard.

Ionic conductivity of solid-state electrolyte membrane: its ionic conductivity was calculated by using a formula L/RS, where L represented a diaphragm thickness (cm), R represented Ohmic impedance (Ω), and S represented a diaphragm area (cm²).

Impedance of solid-state electrolyte membrane: a steel plate was clamped on both sides of the diaphragm, and impedance was tested on an electrochemical workstation.

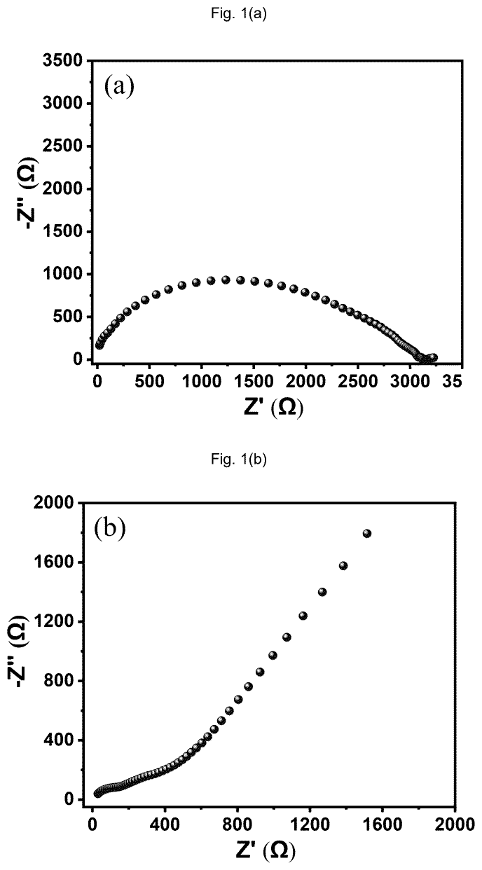

The solid-state electrolyte membranes in the above embodiments and comparative embodiments were assembled into lithium ion solid-state batteries respectively with a high nickel ternary cathode NCM811 (Ni_{0.8}Co_{0.1}Mn_{0.1}) and a graphite anode. Within a frequency range of 1 MHz-0.1 Hz, an Electrochemical Impedance Spectroscopy (EIS) test was performed on an amplitude of an alternating-current voltage at 5 mV. FIG. 1(a) was an EIS diagram of a solid-state battery corresponding to the solid-state electrolyte membrane before heat pressing in Comparative embodiment 1. FIG. 1(b) was an EIS test diagram of the solid-state battery corresponding to the solid-state electrolyte membrane after heat pressing in Embodiment 1.

According to test results in the figures, it might be seen that an impedance value significantly reduced after heat pressing, and if the impedance value is smaller, the charging and discharging efficiency of a battery is higher.

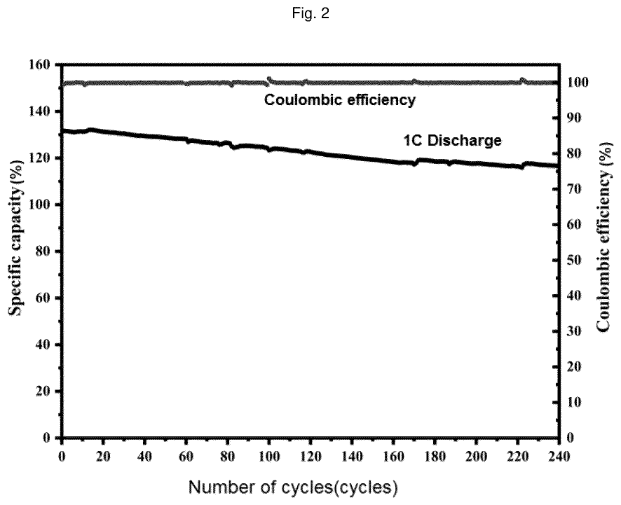

FIG. 2 was a test diagram of cycling performance of a full battery of the solid-state electrolyte membrane shown in Embodiment 1 of the present disclosure. From FIG. 2, it might be seen that the battery using the solid-state electrolyte membrane had a charging and discharging capability at a high rate, a battery constant current at a rate of 1 C was charged to 4.25 V, a constant current was discharged to 2.5 V, and a capacity retention rate for 240 cycles at a rate of 1 C remained at 88%.

The capacity retention rate for 240 cycles at the rate of 1 C and energy density of the lithium ion solid-state battery obtained in the above embodiments and comparative embodiments were tested, and all the above test results were listed in Table 1.

TABLE 1

| | | | | Capacity | |
|---|---|---|---|---|---|
| | | | | retention | |
| | | | | rate (%) | |
| | | | | of lithium | |
| | | | | ion | Energy |
| | Mechanical | Ionic | | solid-state | density |
| | strength | conductivity | Impedance | battery | (Wh/kg) |
| | (MPa) of | (S/cm) of | (Ω) of | for 240 | of lithium |
| Embodiment/ | solid-state | solid-state | solid-state | cycles at | ion |
| comparative | electrolyte | electrolyte | electrolyte | a rate of | solid-state |
| embodiment | membrane | membrane | membrane | 1C | battery |
| Embodiment 1 | 75 | 6.57 × 10⁻⁴ | 153 | 88 | 281 |
| Embodiment 2 | 82 | 6.01 × 10⁻⁴ | 309 | 82 | 226 |
| Embodiment 3 | 83 | 6.26 × 10⁻⁴ | 212 | 84 | 288 |
| Embodiment 4 | 85 | 5.53 × 10⁻⁴ | 432 | 79 | 204 |
| Embodiment 5 | 73 | 7.07 × 10⁻⁴ | 107 | 91 | 354 |
| Embodiment 6 | 51 | 8.05 × 10⁻⁴ | 105 | 88 | 283 |
| Embodiment 7 | 92 | 5.12 × 10⁻⁴ | 212 | 82 | 227 |
| Embodiment 8 | 75 | 5.16 × 10⁻⁴ | 202 | 84 | 242 |
| Embodiment 9 | 81 | 7.13 × 10⁻⁴ | 106 | 88 | 281 |
| Embodiment 10 | 72 | 5.53 × 10⁻⁴ | 101 | 83 | 279 |
| Embodiment 11 | 83 | 6.04 × 10⁻⁴ | 215 | 84 | 224 |
| Embodiment 12 | 65 | 5.02 × 10⁻⁴ | 84 | 73 | 310 |
| Comparative | 75 | 7.03 × 10⁻⁵ | 812 | 73 | 211 |
| embodiment 1 | | | | | |
| Comparative | 83 | 2.01 × 10⁻⁴ | 514 | 78 | 217 |
| embodiment 2 | | | | | |
| Comparative | 97 | 1.02 × 10⁻⁵ | 1055 | 68 | 202 |
| embodiment 3 | | | | | |

It may be seen from the above description that, in the above embodiments of the present disclosure, the following technical effects are realized.

For the solid-state electrolyte membrane with the above structure and composition, in an aspect, a portion of the first solid-state electrolyte is filled in the porous structure of the base membrane, and in the case where the thickness of the solid electrolyte membrane is constant, the mechanical strength of the solid electrolyte membrane is effectively improved, and a short circuit in a battery caused by punctures is prevented. In another aspect, at least a portion of the first solid-state electrolyte layer can be in direct contact with the second solid-state electrolyte layer through a plurality of holes (e.g., the through holes) of the base membrane, causing the contact between the first solid-state electrolyte and the second solid-state electrolyte to be closer, such that interface impedance is reduced, and lithium ion transmission efficiency is improved. Therefore, through the above plurality of factors, the solid-state electrolyte membrane can take lower impedance and higher energy density into consideration while having excellent mechanical properties.

The above are only the preferred embodiments of the present disclosure and are not intended to limit the present disclosure. For those skilled in the art, the present disclosure may have various modifications and variations. Any modifications, equivalent replacements, improvements and the like made within the spirit and principle of the present disclosure all fall within the scope of protection of the present disclosure.

What is claimed is:

1. A solid-state electrolyte membrane, comprising a first solid-state electrolyte layer, a base membrane containing a porous structure, and a second solid-state electrolyte layer, which are sequentially stacked in a thickness direction of the solid-state electrolyte membrane, wherein at least a portion of first solid-state electrolyte in the first solid-state electrolyte layer is filled in the porous structure of the base membrane, and the porous structure comprises a through hole.

2. The solid-state electrolyte membrane according to claim 1, wherein the first solid-state electrolyte accounting for 30 wt %-70 wt % of the total mass of the first solid-state electrolyte layer is filled in the porous structure of the base membrane.

3. The solid-state electrolyte membrane according to claim 1, wherein mechanical strength of the solid-state electrolyte membrane is 20 MPa-100 MPa; and/or ionic conductivity of the solid-state electrolyte membrane is 1×10⁻⁵ S/cm-9×10⁻³ S/cm; and/or impedance of the solid-state electrolyte membrane is 10Ω-1100 Ω.

4. The solid-state electrolyte membrane according to claim 1, wherein a melting point of the base membrane and a melting point of the second solid-state electrolyte in the second solid-state electrolyte layer both are higher than a melting point of the first solid-state electrolyte in the first solid-state electrolyte layer.

5. The solid-state electrolyte membrane according to claim 1, wherein a pore diameter of the through hole is 25 μm-150 μm; and/or a gap between the adjacent through holes is 10 μm-200 μm.

6. The solid-state electrolyte membrane according to claim 1, wherein a melting point of the base membrane is 200 °C-600 °C.

7. The solid-state electrolyte membrane according to claim 1, wherein a thickness of the base membrane is 3 μm-20 μm.

8. The solid-state electrolyte membrane according to claim 1, wherein the base membrane is selected from any one of more of polyethylene, polypropylene, non-woven fabric, aramid fiber, polyvinylidene fluoride, silicon oxide, and aluminum oxide.

9. The solid-state electrolyte membrane according to claim 1, wherein a melting point of the first solid-state electrolyte is 50 °C-150 °C.

10. The solid-state electrolyte membrane according to claim 1, wherein the first solid-state electrolyte is selected from any one of polyethylene glycol, polyethylene oxide, lithium borohydride, lithium phosphate sulfide, lithium bis(trifluoromethanesulphonyl)imide, Li₇La₃Zr₂O₁₂, and anti-perovskite.

11. The solid-state electrolyte membrane according to claim 1, wherein a melting point of a second solid-state electrolyte in the second solid-state electrolyte layer is 200 °C-500 °C.

12. The solid-state electrolyte membrane according to claim 1, wherein the second solid-state electrolyte layer comprises a sulfide solid-state electrolyte, and the sulfide solid-state electrolyte is selected from at least one of Li₆PS₅Cl, Li₁₀GeP₂S₁₂, Li₃PS₄, or Li₇P₃S₁₁.

13. The solid-state electrolyte membrane according to claim 1, wherein a thickness of the solid-state electrolyte membrane is 20 μm-80 μm.

14. A method for preparing the solid-state electrolyte membrane according to claim 1,
wherein the preparation method comprises:
S1: mixing first solid-state electrolyte, a first binder, and a first solvent to obtain a first slurry; and mixing a second solid-state electrolyte, a second binder, and a second solvent to obtain a second slurry;
S2: respectively coating the first slurry and the second slurry on two opposite surfaces in a thickness direction of a base membrane, so as to obtain a wet membrane; and
S3: performing a heat treatment on the wet membrane to obtain a solid-state electrolyte membrane, wherein
the heat treatment comprises heat pressing, a heat pressing temperature is higher than a melting-point temperature of the first solid-state electrolyte, and is lower than melting-point temperatures of the second solid-state electrolyte and the base membrane.

15. The preparation method according to claim 14, wherein a mass ratio of the first solid-state electrolyte to the first binder is (49:1)-(4:1), and/or a mass ratio of the first solid-state electrolyte to the first solvent is (6:4)-(7:5).

16. The preparation method according to claim 14, wherein a mass ratio of the second solid-state electrolyte to the second binder is (49:1)-(4:1), and/or a mass ratio of the second solid-state electrolyte to the second solvent is (6:4)-(7:5).

17. The preparation method according to claim 14, wherein the first binder and the second binder are each independently selected from at least one of polyacrylic acid, acrylonitrile-butadiene rubber, styrene butadiene rubber, sodium carboxymethyl cellulose, polyvinylidene fluoride, or polyethylene oxide; and the first solvent and the second solvent are each independently selected from at least one of toluene, dichloromethane, 1,2-dimethoxyethane, acetonitrile, chloroform, cyclohexanone, methyl acetate, ethyl acetate, or tetrahydrofuran.

18. The preparation method according to claim 14, wherein the process of the heat treatment is to dry the wet membrane first and then perform heat pressing.

19. The preparation method according to claim 18, wherein a drying temperature is 60 °C-100 °C, and/or a drying time is 6 h-12 h.

20. The preparation method according to claim 18, wherein a heat pressing temperature is 65 °C-250 °C, a heat pressing pressure is 1 MPa~30 MPa, and a heat pressing time is 5 min-60 min.
